(19) United States
(12) Patent Application Publication
(10) Pub. No.: US 2025/0100837 A1
(43) Pub. Date: Mar. 27, 2025

(54) CHARGE NEUTRALIZER, IMAGE FORMING APPARATUS, AND IMAGE FORMING SYSTEM

(71) Applicants: Akio KOSUGE, Kanagawa (JP); Kaori Hemmi, Kanagawa (JP)

(72) Inventors: Akio KOSUGE, Kanagawa (JP); Kaori Hemmi, Kanagawa (JP)

(21) Appl. No.: 18/897,478

(22) Filed: Sep. 26, 2024

(30) Foreign Application Priority Data
Sep. 26, 2023 (JP) 2023-163108
Jun. 12, 2024 (JP) 2024-095152
Jul. 22, 2024 (JP) 2024-117011

(51) Int. Cl. B65H 37/00; G03G 15/00

(52) U.S. Cl. CPC B65H 37/00; G03G 15/6573; G03G 15/80; B65H 2301/5133; B65H 2555/40; B65H 2801/06

(57) ABSTRACT

A charge neutralizer includes a first power source, a first charge neutralizer, a second power source, and a second charge neutralizer. The first power source outputs a first neutralizing bias having a first polarity. The first charge neutralizer is coupled to the first power source to remove charge having a second polarity opposite to the first polarity of the first neutralizing bias on one face of a recording medium. The second power source outputs a second neutralizing bias having the second polarity. The second charge neutralizer is coupled to the second power source to remove charge having the first polarity on another face of the recording medium.

### CROSS-REFERENCE TO RELATED APPLICATIONS

This patent application is based on and claims priority pursuant to 35 U.S.C. § 119(a) to Japanese Patent Applications No. 2023-163108, filed on Sep. 26, 2023, No. 2024-095152, filed on Jun. 12, 2024, and No. 2024-117011, filed on Jul. 22, 2024, in the Japan Patent Office, the entire disclosure of which are hereby incorporated by reference herein.

### BACKGROUND

### Technical Field

Embodiments of the present disclosure relate to a charge neutralizer, an image forming apparatus, and an image forming system.

### Related Art

In the related art, an image forming system including an image forming apparatus and a charge neutralizer is known. The image forming apparatus includes a fixing device that applies heat and pressure to a recording sheet to which a toner image is transferred to fix the toner image to the recording sheet. The charge neutralizer includes an electric charge control part and a static eliminating part. The electric charge control part applies voltage to the recording sheet having the toner images fixed to both sides to collect electric charge to a second surface, of the two surfaces of the recording sheet, to which the toner image is fixed later. The static eliminating part is provided downstream from the electric charge control part in a recording sheet conveyance direction and removes the electric charge collected to the second surface.

### SUMMARY

This specification describes an improved charge neutralizer that includes a first power source, a first charge neutralizer, a second power source, and a second charge neutralizer. The first power source outputs a first neutralizing bias having a first polarity. The first charge neutralizer is coupled to the first power source to remove charge having a second polarity opposite to the first polarity of the first neutralizing bias on one face of a recording medium. The second power source outputs a second neutralizing bias having the second polarity. The second charge neutralizer is coupled to the second power source to remove charge having the first polarity on another face of the recording medium.

This specification also describes an image forming apparatus and an image forming system that include the charge neutralizer.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of a configuration of a charge neutralizer;

FIG. 2 is a schematic diagram of a configuration of an image forming apparatus;

FIG. 3 is a graph illustrating an occurrence frequency distribution of charged potentials of recording media ejected from an image forming apparatus when charges on each of the recording media are not neutralized;

FIG. 4 is a graph illustrating an example of an occurrence frequency distribution of charged potentials of recording media ejected from the image forming apparatus after neutralizing charges on the recording media;

FIG. 5 is a graph illustrating another example of an occurrence frequency distribution of charged potentials of recording media ejected from the image forming apparatus after neutralizing charges on the recording media;

FIG. 6 is a schematic diagram of an example of a configuration of an image forming system;

FIG. 7 is a schematic diagram of another example of a configuration of an image forming system;

FIG. 8 is a block diagram illustrating an example of a hardware configuration of an image forming apparatus;

FIG. 9 is a block diagram illustrating a hardware configuration of a charge neutralizer; and

FIG. 10 is a flowchart of control performed by a central processing unit (CPU) to control a charge neutralizer.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings. In the description of the drawings, like reference signs denote like elements, and explanations of them will not be repeated.

### <Configuration of Charge Neutralizer>

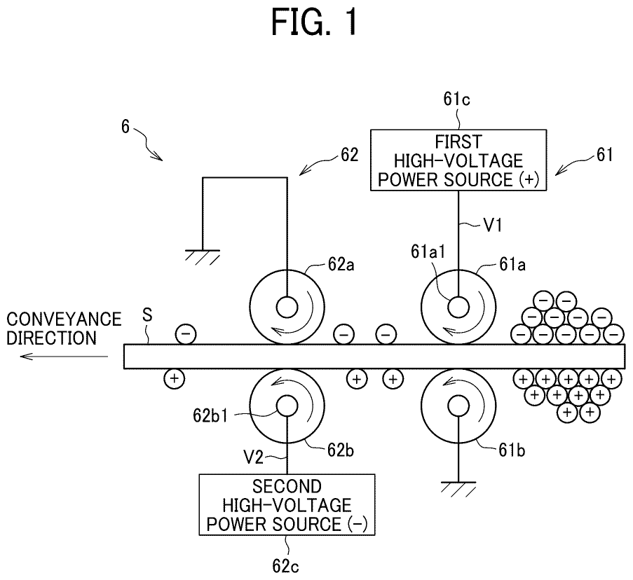

Firstly, a configuration of a charge neutralizer according to an embodiment is described below with reference to FIG. 1. FIG. 1 is a schematic diagram of a configuration of a charge neutralizer 6.

The charge neutralizer 6 includes a first charge neutralizer 61 and a second charge neutralizer 62. The first charge neutralizer 61 includes, for example, a pair of discharging rollers 61a and 61b that conveys a recording medium S. Each of the discharging rollers 61a and 61b is preferably, for example, a conductive roller having an elastic layer made of conductive rubber or conductive sponge formed on the core of each of the discharging rollers 61a and 61b to achieve both conveyance performance to convey the recording medium S and electric charge neutralizing performance to neutralize the charges on the recording medium S. A core 61al of the discharging roller 61a is coupled to a first high-voltage power source 61c. The first high-voltage power source 61c applies a voltage V1 to the discharging roller 61a. The voltage V1 has a polarity opposite to the polarity of the charge (the negative charge in the present embodiment) on one face of the recording medium S. The discharging roller 61a is in contact with the one face of the recording medium S to apply the voltage V1 to the one face of the recording medium S, and the voltage V1 has the polarity opposite to the charge generated on the one face. The voltage V1 is an example of a first neutralizing bias. The polarity of the voltage V1 is an example of a first polarity, and the polarity of the charge on the one face of the recording medium S is an example of a second polarity.

The second charge neutralizer 62 is disposed downstream from the first charge neutralizer 61 in a conveyance direction of the recording medium S in which the recording medium S is conveyed. The second charge neutralizer 62 includes, for example, a pair of discharging rollers 62a and 62b that conveys the recording medium S. Each of the discharging rollers 62a and 62b is also preferably, for example, a conductive roller having an elastic layer made of conductive rubber or conductive sponge formed on the core of each of the discharging rollers 62a and 62b to achieve both conveyance performance to convey the recording medium S and the electric charge neutralizing performance to neutralize the charges on the recording medium S.

A core 62b1 of the discharging roller 62b is coupled to a second high-voltage power source 62c. The second high-voltage power source 62c applies a voltage V2 to the discharging roller 62b. The voltage V2 has a polarity opposite to the polarity of the charge (the positive charge in the present embodiment) on the other face of the recording medium S. The discharging roller 62b is in contact with the other face of the recording medium S that is the face opposite to the face in contact with the discharging roller 61a to apply the voltage V2 to the other face of the recording medium S, and the voltage V2 has the polarity opposite to the charge generated on the other face. The voltage V2 is an example of a second neutralizing bias.

The negative charges and the positive charges on the recording medium S are generated by a process such as a transfer process to transfer a toner image onto the recording medium performed by a processing device such as an image forming apparatus disposed upstream from the charge neutralizer 6 in the conveyance direction of the recording medium S.

When the recording medium is a sheet of plain paper, the volume resistance is low, and thus the charge easily flows through the sheet. The charges given by a neutralizing bias also easily pass through the sheet of plain paper. Therefore, applying the neutralizing bias to either one of the one face of the sheet of plain paper or the other face of the sheet of plain paper can neutralize the charges on the one face of the sheet of plain paper. In other words, applying a voltage to the one face of the sheet, the voltage having a polarity opposite to the polarity of the charges generated on the one face of the sheet can neutralize the charges on the one face of the sheet, and applying a voltage to the other face of the sheet, which is the voltage having the same polarity as the polarity of the charges generated on the one face that is opposite to the other face, can neutralize the charges on the one face on the sheet.

By contrast, in a recording medium such as a resin film (high-resistance medium) having a higher volume resistance than the volume resistance of the sheet of plain paper, applying the voltage having the same polarity of the one face of the recording medium to the other face of the recording medium may not sufficiently neutralize the charges on the one face of the high-resistance medium, which is different from the situation in the sheet of plain paper. For this reason, directly applying the voltage to the one face of the recording medium, the voltage having the polarity opposite to the polarity of the charge on the one face more easily neutralizes the charges on the one face of any one of various recording media.

The first charge neutralizer 61 neutralizes the charges on the one face such as the front face of the recording medium S. Subsequently, the second charge neutralizer 62 neutralizes the charges on the other face such as the back face of the recording medium S. Thus, most of the charges in the recording medium S are removed, and the recording medium S is sent out from the charge neutralizer 6.

The order of neutralizing the charges in the recording medium S is not limited to the above-described order in which the charges on the front face are neutralized and then the charges on the back face are neutralized. For example, the first charge neutralizer 61 and the second charge neutralizer 62 may be replaced with each other so that the first charge neutralizer 61 is positioned downstream from the second charge neutralizer 62 in the conveyance direction of the recording medium S to firstly neutralize the charges on the back face of the recording medium S and secondly neutralize the charges on the front face of the recording medium S.

As described above, the charge neutralizer 6 in the present embodiment includes the first charge neutralizer 61 and the second charge neutralizer 62 to remove the charges in the recording medium S in which the charges are generated. The first charge neutralizer 61 applies the voltage V1 to the one face of the recording medium, the voltage V1 having the polarity opposite to the polarity of the charges (negative charges in the present embodiment) on the one face of the recording medium S. The second charge neutralizer 62 applies the voltage V2 to the other face of the recording medium S, the voltage V2 having the polarity opposite to the polarity of the charges (positive charges in the present embodiment) on the other face of the recording medium S.

In addition, the first charge neutralizer 61 is disposed upstream or downstream from the second charge neutralizer 62 in the conveyance direction of the recording medium S.

The above-described configuration can effectively remove the charges even in the high-resistance medium. Accordingly, the above-described configuration can prevent the high-resistance medium from sticking to a conveyance path, reduce mismatches among postures of media ejected to an output tray, and prevent the recording media stacked on the output tray from sticking to each other. As a result, the above-described configuration can give good handling properties even in the high-resistance medium.

Preferably, the first high-voltage power source 61c that applies the voltage V1 to the discharging roller 61a and the second high-voltage power source 62c that applies the voltage V2 to the discharging roller 62b output direct current (DC) biases that are controlled to flow constant currents.

For example, the charge neutralizer 6 used in an image forming apparatus described below is disposed downstream from a fixing device that fixes a toner image on the recording medium S in the conveyance direction. Since the recording media are heated to a high temperature by the fixing device and fed into the charge neutralizer 6, continuously operating the image forming apparatus increases the temperature of the discharging rollers 61a and 62b due to the recording media, which is likely to decrease the resistance of the discharging rollers 61a and 62b.

The DC bias controlled to a constant voltage causes an excessive current to flow in each of the discharging rollers 61a and 62b that decrease the resistance as described above. In contrast, the DC bias controlled to flow the constant current maintains the current value regardless of the temperature change of the discharging rollers 61a and 62b, and therefore, can appropriately neutralize the charges in the recording medium even when the resistance of the discharging rollers 61a and 62b changes.

As described above, the voltage V1 and the voltage V2 in the present embodiment are DC biases subjected to constant current control. The above-described configuration can maintain a good charge neutralization performance even when the resistances of the discharging rollers 61a and 62b change.

### <Configuration of Image Forming Apparatus>

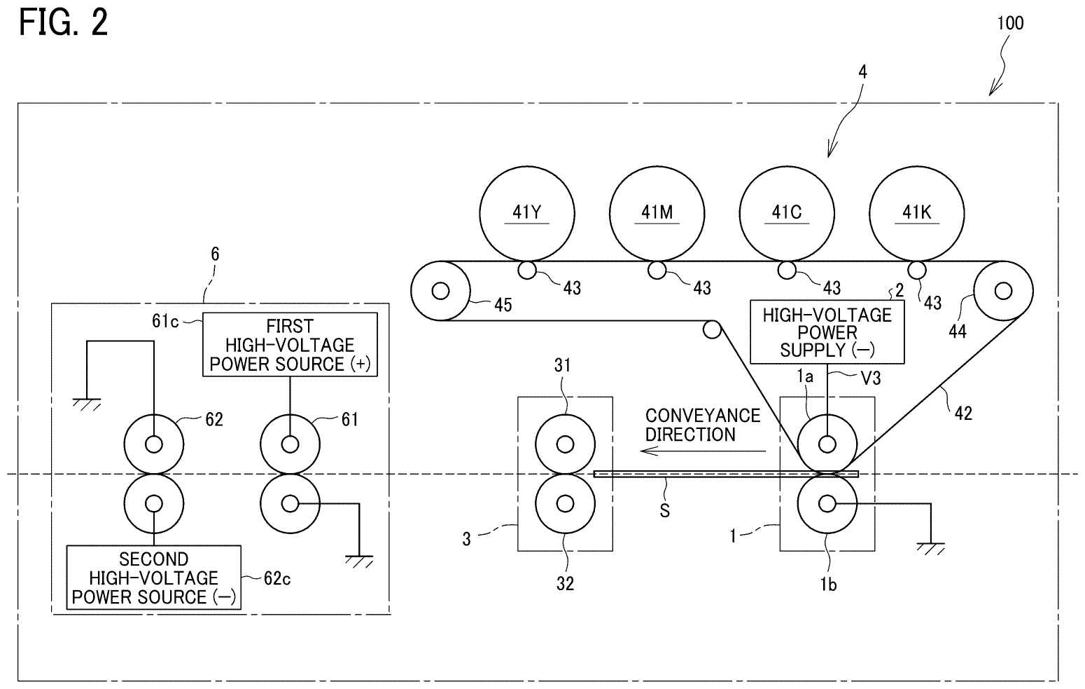

Secondly, a configuration of the image forming apparatus according to the embodiment is described with reference to FIG. 2. FIG. 2 is a schematic diagram of the configuration of the image forming apparatus.

The image forming apparatus in the present embodiment described below has the configuration in which a toner image developed on the photoconductor is transferred to an intermediate transfer belt and further secondarily transferred from the intermediate transfer belt to a recording medium such as a sheet or a film, but the configuration of the image forming apparatus is not limited this. For example, the image forming apparatus may not include the intermediate transfer belt and may be configured to directly transfer the toner image developed on the photoconductor to the recording medium.

An image forming apparatus 100 includes a transfer device 1, a high-voltage power supply 2, a fixing device 3, an image forming section 4, and the charge neutralizer 6.

The image forming section 4 includes a tandem type structure including image forming units 41Y, 41M, 41C, and 41K and an intermediate transfer belt 42. The image forming units 41Y, 41M, 41C, and 41K form a yellow (Y) toner image, a magenta (M) toner image, a cyan (C) toner image, and a black (K) toner image, respectively. An optical writing device writes images in the image forming units. In the image forming section 4, the image forming units 41Y, 41M, 41C, and 41K perform image forming processes so that the images written by the optical writing device form a full-color toner image on the intermediate transfer belt 42.

Specifically, the image forming units 41Y, 41M, 41C, and 41K include four rotatable photoconductor drums Y, M, C, and K, respectively, and include image forming components. The image forming components in each of the image forming units include a charging roller, a developing device, a primary transfer roller, a cleaner, and a charge neutralizer that are disposed around each photoconductor drum.

The image forming components operate on each photoconductor drum to form an image. Each of primary transfer rollers 43 transfers the image from the photoconductor drum to the intermediate transfer belt 42. The intermediate transfer belt 42 is in the nips between the photoconductor drums and the corresponding primary transfer rollers 43 and stretched by a drive roller 44 and a driven roller 45.

The transfer device 1 includes a pair of a repulsive force roller 1a and a secondary transfer roller 1b. The transfer device 1 transfers the full-color toner image on the intermediate transfer belt 42 to the recording medium S conveyed in the conveyance direction along a conveyance path indicated by a broken line in FIG. 2. The high-voltage power supply 2 applies a voltage V3 to the repulsive force roller 1a in the transfer device 1, the voltage V3 has the same polarity as the polarity of charged toner in the full-color toner image transferred to the intermediate transfer belt 42. The voltage V3 is an example of a secondary transfer bias. In the transfer device 1, pressure applied by the secondary transfer roller 1b and an electric repulsive force generated by the voltage V3 applied to the repulsive force roller 1a transfers, to the recording medium S, the full-color toner image including the yellow (Y) toner image, the magenta (M) toner image, the cyan (C) toner image, and the black (K) toner image on the intermediate transfer belt 42.

The recording medium S on which the full-color toner image has been secondarily transferred is conveyed to the fixing device 3, and the fixing device 3 fixes the full-color toner image onto the recording medium S. The fixing device 3 is, for example, a thermal fixing type fixing device, and includes a fixing roller 31 and a pressure roller 32 contacting each other to form a nip. The recording medium S to which the toner image has been transferred passes through the nip between the fixing roller 31 and the pressure roller 32 to apply heat and pressure to the recording medium S. As a result, the toner on the recording medium S is melted, and the full-color toner image is fixed to the recording medium S.

The recording medium S on which the toner image is fixed is conveyed to the charge neutralizer 6. The recording medium S used in the image forming apparatus 100 is not limited to paper such as plain paper or coated paper. A resin film can be used as long as the resin film is made of a material having heat resistance to withstand the heat in the fixing device and having an affinity with the toner.

However, since the resin film has a higher volume resistance than the sheet of paper as described above, the charge generated by the transfer device 1 when the toner image is transferred remains in the resin film. Since the generated charges in the sheet of plain paper are immediately diffused, the sheet of plain paper is hardly charged after the full-color toner image is fixed, but the resin film holds charges given by a transfer process, and therefore, the resin film is charged after the full-color toner image is fixed. As a result, disadvantages occur such as the charged resin film sticking to the conveyance path, mismatching the postures of the resin films ejected to the output tray, and the resin films sticking to each other on the output tray.

To countermeasure the above-described disadvantages, the image forming apparatus 100 in the present embodiment includes the charge neutralizer 6 downstream from the fixing device 3 in the conveyance direction, and the charge neutralizer 6 neutralizes the charges on both the front face and the back face of the recording medium S. The configuration of the charge neutralizer 6 is the same as that described in FIG. 1, and thus the description thereof will be omitted.

As described above, the image forming apparatus 100 according to the present embodiment includes the transfer device 1 that applies the voltage V3 to the recording medium S to transfer the toner image onto the recording medium S, the fixing device 3 that fixes the transferred toner image onto the recording medium S, and the charge neutralizer 6 that removes the charges given by the transfer device 1 from the recording medium S on which the toner image is fixed. As a result, the above-described image forming apparatus can give good handling properties even in the high-resistance medium such as the resin film.

### <Hardware Configuration of Image Forming Apparatus>

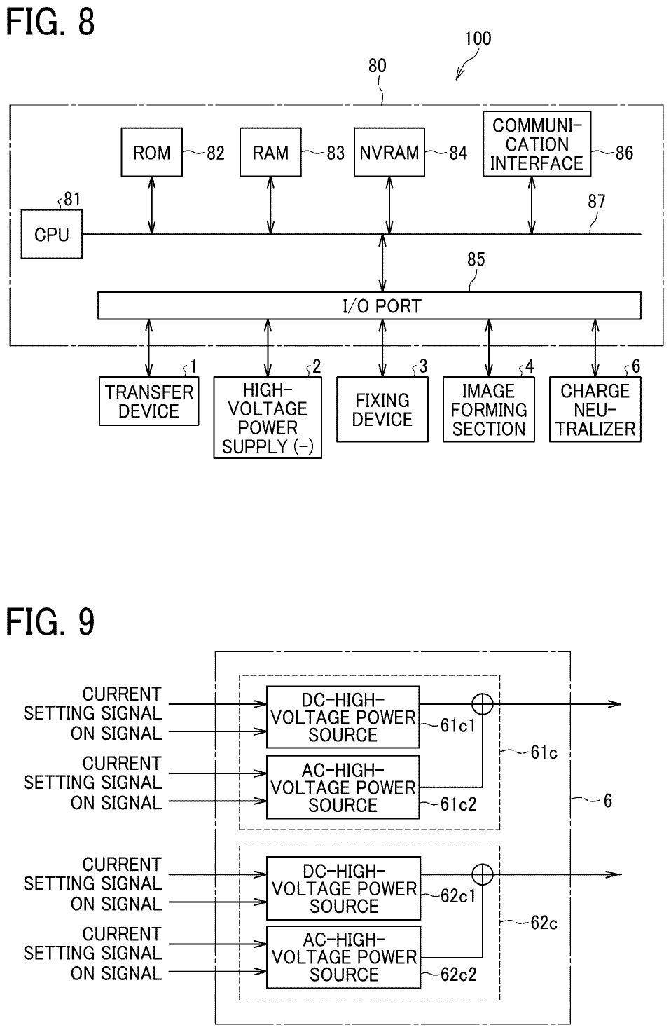

Thirdly, a hardware configuration of the image forming apparatus 100 according to the embodiment is described with reference to FIG. 8. FIG. 8 is a block diagram illustrating an example of the hardware configuration of the image forming apparatus 100.

A controller 80 includes a central processing unit (CPU) 81, a read-only memory (ROM) 82, a random-access memory (RAM) 83, a non-volatile random-access memory (NVRAM) 84, an input and output device (I/O port) 85, and a communication interface (I/F) 86, which are connected to each other via a bus 87.

The CPU 81 is a calculator or computing device that controls an overall operation of the image forming apparatus 100. The ROM 82 is a read-only non-volatile storage medium that stores programs such as firmware. The RAM 83 is a volatile storage medium that allows data to be read and written at high speed. The CPU 81 uses the RAM 83 as a work area for data processing. The NVRAM 84 is a non-volatile storage medium that allows data to be read and written and stores setting values required to control various units in the image forming apparatus 100 such as voltage values applied to the charge neutralizer 6 according to paper types. The programs stored in the ROM 82 are read out to the RAM 83, and the CPU 81 performs arithmetic operations in accordance with the programs loaded to the RAM 83, thereby controlling various units of the image forming apparatus 100. The CPU 81 uses the setting values stored in the NVRAM 84 to control the various units.

The I/O port 85 is connected to the transfer device 1, the high-voltage power supply 2, the fixing device 3, the image forming section 4, and the charge neutralizer 6 in the image forming apparatus 100, receives outputs of sensors disposed in these devices, and outputs signals to control the transfer device 1, the high-voltage power supply 2, the fixing device 3, the image forming section 4, and the charge neutralizer 6 based on sensor signals received. For example, regarding the fixing device 3, output signals of a thermistor as a temperature detector are input to the I/O port 85, and the CPU 81 controls turning on and off a heater based on the temperature indicated by the thermistor via the I/O port 85 to control the fixing process of the fixing device 3.

The communication I/F 86 is connected to an operation unit of the image forming apparatus 100, and the value of the current (or the voltage) applied to the charge neutralizer 6, which is set by the operation unit, is stored in the NVRAM 84. The value of the current (or the voltage) is determined with reference to the secondary transfer bias. The first neutralizing bias of the first charge neutralizer has a polarity opposite to that of the secondary transfer bias and an absolute value of about 90% of the secondary transfer bias, and the second neutralizing bias of the second charge neutralizer has the same polarity as that of the secondary transfer bias and an absolute value of about 10% of the secondary transfer bias. Additionally, the NVRAM 84 may store correction values that are different depending on the type of film sheet used.

### <Hardware Configuration of Charge Neutralizer>

FIG. 9 is a block diagram illustrating a hardware configuration of the charge neutralizer 6.

The charge neutralizer 6 includes the first high-voltage power source 61c and the second high-voltage power source 62c. The first high-voltage power source 61c includes a DC-high-voltage power source 61cl and an AC-high-voltage power source 61c2, and the second high-voltage power source 62c includes a DC-high-voltage power source 62cl and an AC-high-voltage power source 62c2. The first high-voltage power source 61c and the second high-voltage power source 62c are controlled by a constant current method or a constant voltage method. In the present embodiment, the first high-voltage power source 61c and the second high-voltage power source 62c are controlled by the constant current method. The DC-high-voltage power source 61cl receives an ON signal and a current setting signal set by the CPU 81 based on a target current value stored in the NVRAM 84 via the I/O port 85. The DC-high-voltage power source 61cl outputs a voltage in response to receiving the ON signal and performs feedback control that controls the voltage based on a current value detected by a current detector so that the detected current value becomes the target current value set by the received current setting signal. The DC-high-voltage power source 62cl and the AC-high-voltage power source 62c2 in the second high-voltage power source 62c and the AC-high-voltage power source 61c2 perform the same operation. The first high-voltage power source 61c outputs the voltage superimposing the voltage output by the AC-high-voltage power source 61c2 on the voltage output by the DC-high-voltage power source 61c1. Similarly, the second high-voltage power source 62c outputs the voltage superimposing the voltage output by the AC-high-voltage power source 62c2 on the voltage output by the DC-high-voltage power source 62c1.

### <How to Control Charge Neutralizer>

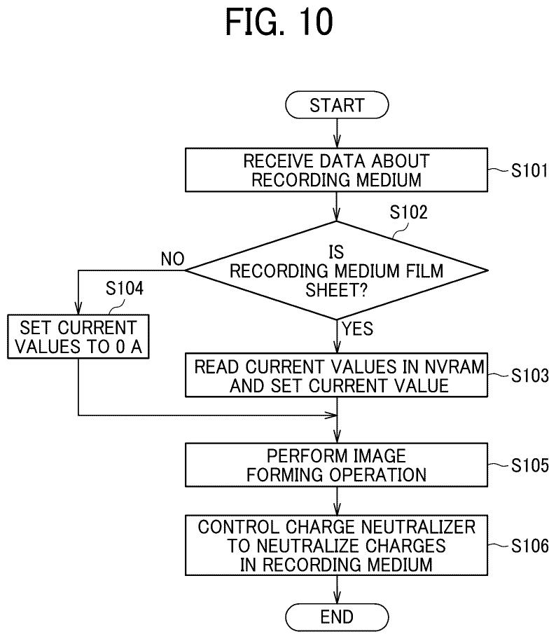

FIG. 10 is a flowchart of control performed by the CPU 81 to control the charge neutralizer 6.

In step S101, the CPU 81 receives data about the recording medium on which the image is to be formed via the communication I/F 86. In step S102, the CPU 81 determines whether the recording medium is the film sheet based on the received data about the recording medium. If the CPU 81 determines that the recording medium is the film sheet (YES in step S102), the CPU 81 reads the current value stored in the NVRAM 84 and determines current values to be output by the first high-voltage power source 61c and the second high-voltage power source 62c in the charge neutralizer 6 in step S103. If the CPU 81 determines that the recording medium is not the film sheet (NO in step S102), the CPU 81 sets current values output by the first high-voltage power source 61c and the second high-voltage power source 62c to be 0 A in step S104. Subsequently, the CPU 81 controls the image forming section 4, the transfer device 1, the high-voltage power source 2, and the fixing device 3 to perform an image forming operation in step S105. In addition, the CPU 81 controls the charge neutralizer 6 in step S106 to neutralize the charges in the sheet output from the fixing device based on the current value set in step S103 or step S104. If the recording medium is the film sheet, the CPU 81 sets the current values determined in step S103 as the current values output by the first high-voltage power source 61c and the second high-voltage power source 62c and turns on the first high-voltage power source 61c and the second high-voltage power source 62c. As a result, the charge neutralizer 6 applies the voltages controlled to flow currents having the set current values to the recording medium after the fixing process to neutralize the charges in the recording medium.

When the recording medium is not the film sheet, the CPU 81 sets the first and second neutralizing biases to be 0 A in the above-described flowchart but may not turn on the charge neutralizer. If necessary, the CPU 81 may set the first and second neutralizing biases for a sheet other than the film sheet to smaller current values than the current values for the film sheet. Since there are various types of film sheets, the setting value may be adjusted according to each type.

### <Comparison of Charged States of Recording Media>

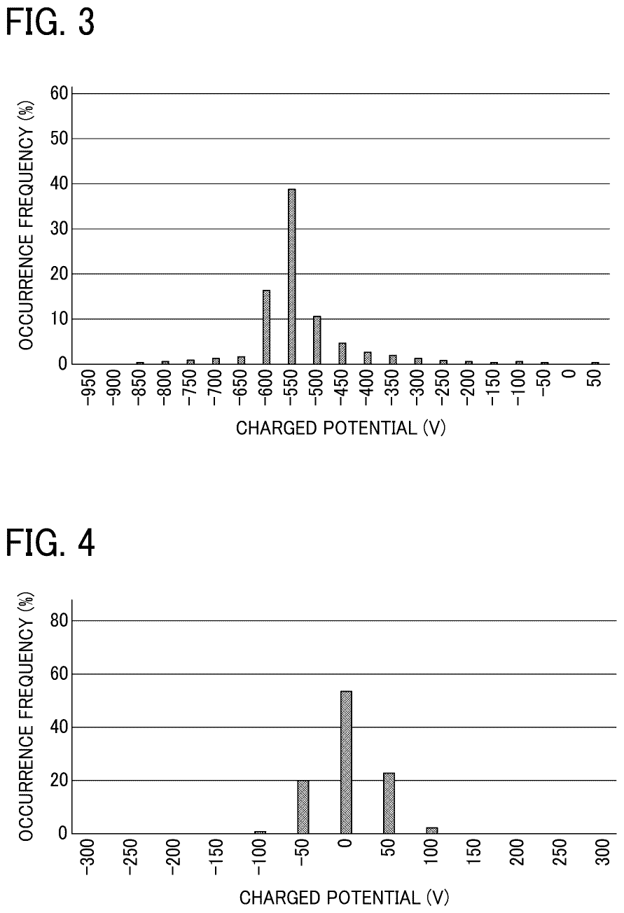

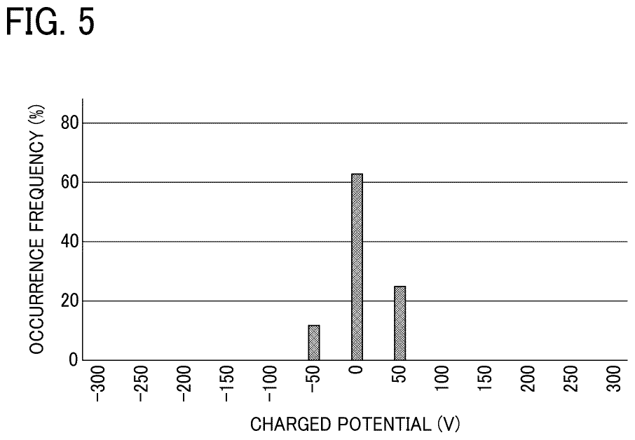

Charged states of the recording media in some cases are described below with reference to FIGS. 3 to 5. FIG. 3 is a graph illustrating an occurrence frequency distribution of charged potentials of recording media ejected from the image forming apparatus when the charges on the recording media are not neutralized. FIG. 4 is a graph illustrating an example of an occurrence frequency distribution of charged potentials of recording media ejected from the image forming apparatus after neutralizing the charges on the recording media. FIG. 5 is a graph illustrating another example of an occurrence frequency distribution of charged potentials of recording media ejected from the image forming apparatus after neutralizing the charges on the recording media.

When the charges on the recording media ejected from the fixing device 3 were not neutralized, the recording media S ejected from the above-described image forming apparatus 100 had the occurrence frequency distribution of charged potentials as illustrated in FIG. 3, and the surfaces of most of the recording media S are charged to about-550V. The recording media used in experiments were waterproof sheets. Polyethylene terephthalate (PET) films were attached to both sides of a sheet of paper to form the waterproof sheet. Measurements were performed as follows. The waterproof sheet ejected from the image forming apparatus was placed on a grounded flat plate made of stainless steel. A probe of a surface electrometer scanned the surface of the waterproof sheet to measure the charged potential.

The charged potential on the back side of the waterproof sheet was measured. It was found that the absolute value of the charged potential on the back side of the waterproof sheet as the recording medium was substantially the same as that on the front side, and the polarity of the charged potential on the back side of the waterproof sheet was opposite to the polarity of the charged potential on the front side. When the image forming apparatus ejects the recording media charged as described above, the negative charges on the front side of the recording medium ejected first and the positive charges on the back side of the recording medium ejected later are electrostatically attracted to each other. Due to the influence of the electrostatic attraction, the recording medium ejected first is pushed out by the recording medium ejected later, and disadvantages occur. For example, the recording media are not stacked on the output tray in a clean manner, or the recording media are stuck to each other on the output tray.

In the charge neutralizer 6 according to the embodiment, the DC biases are controlled to flow constant currents and applied to the discharging roller 61a and the discharging roller 62b. One experiment was performed. The secondary transfer bias was set to −72 μA. The first neutralizing bias was set to 65 μA. The second neutralizing bias was set to −7 μA. These biases were controlled to flow constant currents. Under these conditions, the charge neutralizer 6 neutralized charges in the recording media, and the occurrence frequency distribution of charged potentials was examined. FIG. 4 illustrates the result. As illustrated in FIG. 4, the occurrence frequency of 0 V was 50% or more. The above-described charge neutralizer 6 can reduce the charged potential and the sticking of the recording media. Since 100% of unused recording media had the charged potentials of 0 V, an ideal occurrence frequency distribution of charged potentials of the recording media has a sharp peak in the vicinity of 0 V.

Another experiment was performed. FIG. 5 illustrates the result. In the experiment, superimposed biases in which AC components are superimposed on DC components were applied to the discharging roller 61a and the discharging roller 62b. Specifically, a sinusoidal AC bias having frequencies 3 kHz and a peak-to-peak voltage (Vpp) 3 kV was superimposed on the DC bias to form the superimposed bias and applied to each of the discharging roller 61a and the discharging roller 62b.

As illustrated in FIG. 5, using the superimposed bias gave the occurrence frequency distribution having the peak sharper than the peak in the occurrence frequency distribution illustrated in FIG. 4 in which only the DC bias was applied and reduced the occurrences of the sticking of the recording media. The present inventors consider that this is because the DC bias alone generates only discharge of one polarity, but the superimposed bias generates discharges of both polarities, and therefore, the occurrence frequency distribution was sharpened. As the conditions of the AC bias, sine waves having frequencies of 1 to 4 kHz and a peak-to-peak voltage Vpp of 2 to 4 kV were suitable, and the conditions may be appropriately changed according to specifications.

As a method of setting the neutralizing biases, for example, the first neutralizing bias applied to the discharging roller 61a is set so that the charged potential at the peak of the occurrence frequency distribution of the charged potentials has the absolute value equal to or smaller than 100 v and has the same polarity as the polarity of the charged potential before the charge neutralizer neutralizes the charges in the recording medium. The second neutralizing bias applied to the discharging roller 62b is set so that the charged potential at the peak of the occurrence frequency distribution of the charged potentials is in the vicinity of 0 V, thereby obtaining a good result.

As described above, in the present embodiment, the first neutralizing bias (the voltage V1) applied to the discharging roller 61a and the second neutralizing bias (the voltage V2) applied to the discharging roller 62b are superimposed biases in which AC components are superimposed on DC components. The superimposed biases form the occurrence frequency distribution of the charged potentials that has the sharp peak after neutralizing the charges in the recording medium and enhance the charge neutralizing performance.

### <Configuration of Image Forming System>

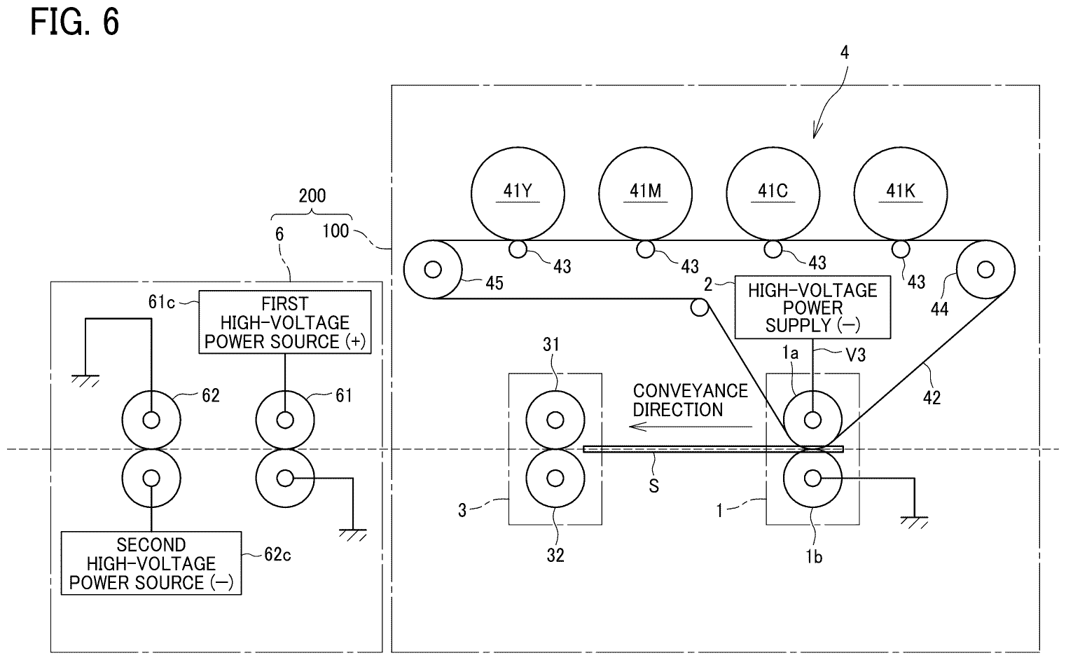

FIG. 6 is a schematic diagram of an example of a configuration of an image forming system.

An image forming system 200 includes the image forming apparatus 100 and the charge neutralizer 6. In other words, the charge neutralizer 6 is not limited to the configuration disposed inside the image forming apparatus 100 as illustrated in FIG. 2 and may be configured as a charge neutralizing apparatus different from the image forming apparatus 100 and connected to a downstream side of the image forming apparatus 100 in the conveyance direction as illustrated in FIG. 6. The configuration of each component is the same as that in FIG. 2, and thus the descriptions thereof are omitted.

As described above, the image forming system 200 according to the present embodiment includes the image forming apparatus 100 including the transfer device 1 that applies the transfer bias to the recording medium to transfer the toner image onto the recording medium and the fixing device 3 that fixes the transferred toner image onto the recording medium, and the charge neutralizer 6 that removes the charges generated by the transfer device 1 from the recording medium on which the toner image is fixed. As a result, the above-described image forming system can give good handling properties even in the high-resistance medium.

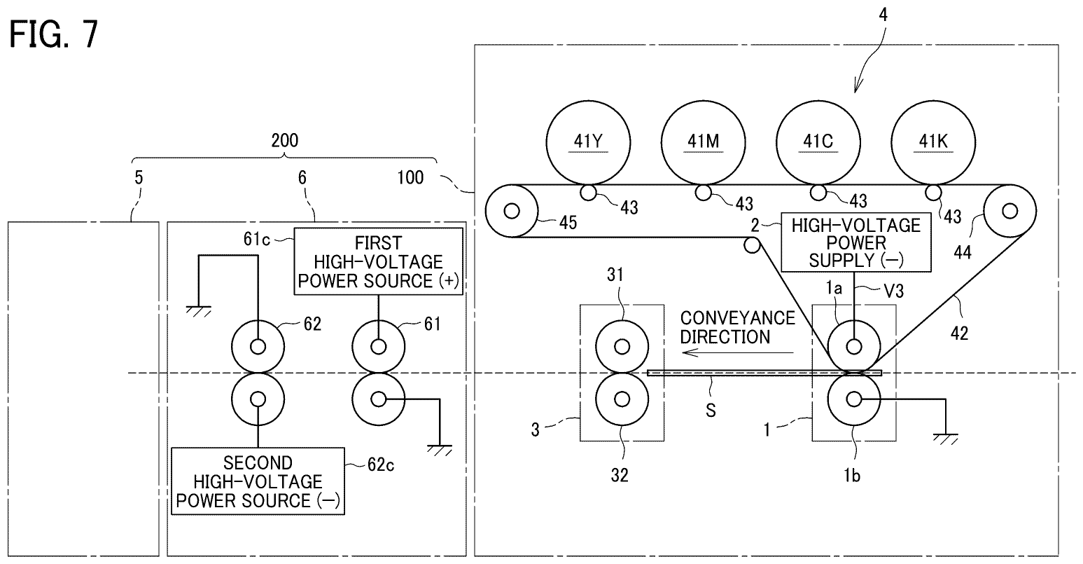

FIG. 7 is a schematic diagram of another example of a configuration of an image forming system.

In addition to the configuration illustrated in FIG. 6, the image forming system 200 may have a configuration including a post-processing apparatus 5 disposed downstream from the charge neutralizing apparatus including the charge neutralizer 6 in the conveyance direction of the recording medium S. The post-processing apparatus 5 performs a predetermined process on the recording medium S.

Since disposing the charge neutralizing apparatus including the charge neutralizer 6 as described above can reduce stacking failure of electrostatically charged recording media and prevent the electrostatically charged recording media from sticking to a conveyance path and sticking to each other, the post-processing apparatus 5 such as the finisher or a stacker coupled to the image forming apparatus can effectively process even the recording medium such as the waterproof sheet.

As described above, the image forming system 200 according to the present embodiment includes the post-processing apparatus 5 disposed downstream from the charge neutralizing apparatus including the charge neutralizer 6 in the conveyance direction of the recording medium S to perform the predetermined process on the recording medium S. The above-described configuration enables the post-processing apparatus to stably output and process a large amount of recording media even when the recording medium having a high resistance such as the waterproof sheet is used.

The above-described embodiments can be changed within the range that can be conceived of by those skilled in the art, such as other embodiments, additions, modifications, and deletions, and the scope of the present disclosure encompasses any aspect, as long as the aspect achieves the operation and advantageous effect of the present disclosure.

### First Aspect

In a first aspect, a charge neutralizer such as the charge neutralizer 6 includes a first power source such as the first high-voltage power source 61c, a first charge neutralizer such as the first charge neutralizer 61, a second power source such as the second high-voltage power source 62c, and a second charge neutralizer such as the second charge neutralizer 62. The first power source outputs a first neutralizing bias having a first polarity. The first charge neutralizer is coupled to the first power source to remove charge having a second polarity opposite to the first polarity of the first neutralizing bias on one face of a recording medium.

The second power source outputs a second neutralizing bias having the second polarity. The second charge neutralizer is coupled to the second power source to remove charge having the first polarity on another face of the recording medium.

### Second Aspect

In a second aspect, the first charge neutralizer in the charge neutralizer according to the first aspect is disposed upstream from the second charge neutralizer in a conveyance direction of the recording medium.

### Third Aspect

In a third aspect, the first charge neutralizer in the charge neutralizer according to the first aspect is disposed downstream from the second charge neutralizer in a conveyance direction of the recording medium.

### Fourth Aspect

In a fourth aspect, each of the first power source and the second power source in the charge neutralizer according to any one of the first to third aspects is a direct current bias power source to supply a constant current.

### Fifth Aspect

In a fifth aspect, each of the first power source and the second power source in the charge neutralizer according to any one of the first to third aspects includes a direct-current-high-voltage power source and an alternate-current-high-voltage power source.

### Sixth Aspect

In a sixth aspect, the charge neutralizer according to any one of the first to fifth aspects includes the first charge neutralizer contacting one face of the recording medium to remove the charge having the second polarity opposite to the first polarity of the first neutralizing bias on the one face of the recording medium and the second charge neutralizer contacting said another face of the recording medium to remove the charge having the first polarity on said another face of the recording medium.

### Seventh Aspect

In a seventh aspect, an image forming apparatus includes an image forming section to form a toner image, a transfer device to transfer the toner image to a recording medium, a fixing device to fix the toner image on the recording medium, and the charge neutralizer according to any one of the first to sixth aspects. The charge neutralizer is disposed downstream from the fixing device in a conveyance direction of the recording medium.

### Eighth Aspect

In an eighth aspect, an image forming system includes an image forming apparatus and the charge neutralizer according to any one of the first to sixth aspects. The image forming apparatus forms a toner image on a recording medium and includes a transfer device and a fixing device. The transfer device transfers the toner image to the recording medium. The fixing device fixes the toner image on the recording medium. The charge neutralizer is disposed downstream from the image forming apparatus in a conveyance direction of the recording medium.

### Ninth Aspect

In a ninth aspect, the image forming system according to the eighth aspect further includes a post-processing apparatus disposed downstream from the charge neutralizer in the conveyance direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A charge neutralizer comprising:
a first power source to output a first neutralizing bias having a first polarity;
a first charge neutralizer coupled to the first power source to remove charge having a second polarity opposite to the first polarity of the first neutralizing bias on one face of a recording medium;
a second power source to output a second neutralizing bias having the second polarity; and
a second charge neutralizer coupled to the second power source to remove charge having the first polarity on another face of the recording medium.

2. The charge neutralizer according to claim 1,
wherein the first charge neutralizer is disposed upstream from the second charge neutralizer in a conveyance direction of the recording medium.

3. The charge neutralizer according to claim 1,
wherein the first charge neutralizer is disposed downstream from the second charge neutralizer in a conveyance direction of the recording medium.

4. The charge neutralizer according to claim 1,
wherein each of the first power source and the second power source is a direct current bias power source to supply a constant current.

5. The charge neutralizer according to claim 1,
wherein each of the first power source and the second power source includes s a direct-current-high-voltage power source and an alternate-current-high-voltage power source.

6. The charge neutralizer according to claim 1,
wherein the first charge neutralizer contacts one face of the recording medium to remove the charge having the second polarity opposite to the first polarity of the first neutralizing bias on the one face of the recording medium, and
the second charge neutralizer contacts said another face of the recording medium to remove the charge having the first polarity on said another face of the recording medium.

7. An image forming apparatus comprising:
an image forming section to form a toner image;
a transfer device to transfer the toner image to a recording medium;
a fixing device to fix the toner image on the recording medium; and
the charge neutralizer according to claim 1, the charge neutralizer disposed downstream from the fixing device in a conveyance direction of the recording medium.

8. An image forming system comprising:
an image forming apparatus to form a toner image on a recording medium, the image forming apparatus including:
a transfer device to transfer the toner image to the recording medium; and
a fixing device to fix the toner image on the recording medium; and
the charge neutralizer according to claim 1, the charge neutralizer disposed downstream from the image forming apparatus in a conveyance direction of the recording medium.

9. The image forming system according to claim 8, further comprising
a post-processing apparatus disposed downstream from the charge neutralizer in the conveyance direction.
